(19) United States
(12) Patent Application Publication
(10) Pub. No.: US 2009/0138158 A1
(43) Pub. Date: May 28, 2009

(54) METHOD FOR OPERATING A SUPERPOSED STEERING SYSTEM FOR A MOTOR VEHICLE

(76) Inventors: Roland GREUL, Lorch-Waldhausen (DE); Joerg Strecker, Pluederhausen (DE); Christopher Kreis, Esslingen (DE)

Correspondence Address: KENYON & KENYON LLP, ONE BROADWAY, NEW YORK, NY, 10004, US

(21) Appl. No.: 12/323,048

(22) Filed: Nov. 25, 2008

(30) Foreign Application Priority Data
Nov. 28, 2007 (DE) 10 2007 000 995.1

(51) Int. Cl. B62D 6/00

(52) U.S. Cl. 701/42

(57) ABSTRACT

In a method for controlling a motor vehicle via driving dynamics, using an auxiliary steering system, including a power steering assistance unit, a superposed transmission, and a final control element to correct a driver-steering angle by applying an auxiliary steering angle, an overall steering angle is formed to modify the wheel-steering angle of steered wheels with the aid of the superposed transmission, and a control and regulation unit assigned to the final control element determines a setpoint for the auxiliary steering angle. When an understeering state is detected, the setpoint of the auxiliary steering angle is modified such that the lateral wheel force is kept within a range of a maximally achievable maximum value for the lateral wheel force, which is dependent upon environmental influences, for the duration of the understeering state.

### CROSS-REFERENCE TO RELATED APPLICATIONS

The present application claims priority to Application No. 10 2007 000 995.1, filed in the Federal Republic of Germany on Nov. 28, 2007, which is expressly incorporated herein in its entirety by reference thereto.

### FIELD OF THE INVENTION

The present invention relates to a method for operating a superposed steering system in a motor vehicle.

### BACKGROUND INFORMATION

German Published Patent Application No. 197 51 125 describes a method for operating a steering system for a motor vehicle, which superimposes the steering motion initiated by the driver of the vehicle and the motion initiated by the final control element with the aid of a final control element and an auxiliary actuator, and a control signal, which is formed by superimposing at least two parallel and independent steering components, is generated for the final control element.

### SUMMARY

Example embodiments of the present invention provide a method for operating a superposed steering system in order to increase the driving safety during cornering.

According to example embodiments of the present invention, when detecting an understeering state of the vehicle, the setpoint of the additional steering angle is modified with the aid of a control and regulation device, such that the lateral wheel force F_{y} is kept within a range of a maximum value for the lateral wheel force, which is assumed to be maximally achievable and affected by environmental influences (coefficient of friction, wheel parameters), for the duration of the detected understeering state.

Further features and aspects of example embodiments of the present invention are described in more detail below with reference to the appended Figures.

### BRIEF DESCRIPTION OF THE DRAWINGS

FIG. 1 schematically illustrates the superposed steering system, located in a steering train, of a motor vehicle, to which the method according to example embodiments of the present invention are applicable.

FIGS. 2a and 2b show the correlation between the slip angle and lateral guiding force or wheel return torque.

FIG. 3 shows a configuration for determining the degree of the instantaneous understeering state.

FIG. 4 shows an example embodiment of the present invention, which uses a differential value between the setpoint and the instantaneous yaw rate.

FIG. 5 shows an example embodiment of the present invention, which uses the instantaneous transverse acceleration and an estimated rack force.

FIG. 6 shows an implementation variant of the method according to example embodiments of the present invention, which uses wheel speeds and a virtual wheel-steering angle.

### DETAILED DESCRIPTION

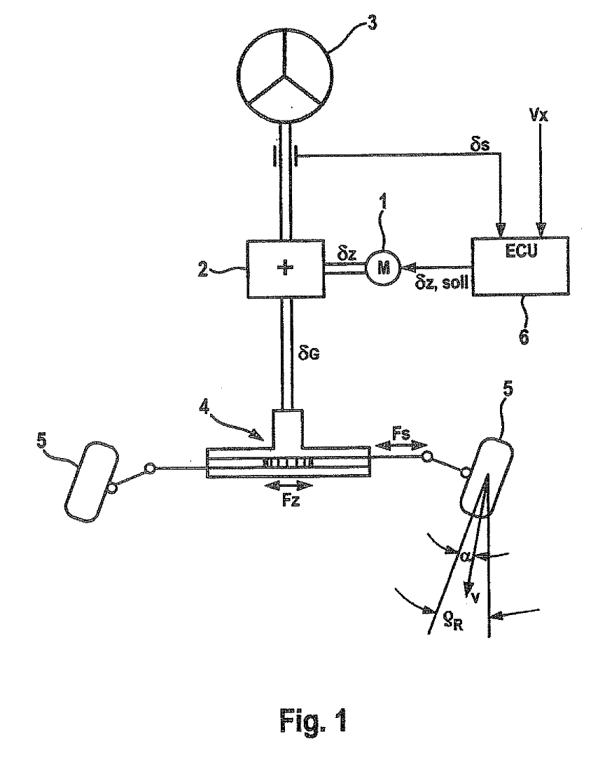

FIG. 1 schematically illustrates an auxiliary steering system of the type mentioned in the introduction, which includes a final control element 1, which applies an auxiliary steering angle δ_{z} as specified by setpoint δ_{z, soll} into the steering train of the steering system with the aid of superimposed transmission 2, and an overall steering angle δ_{G} is formed on the output side and conveyed to the electrically or hydraulically assisted steering gear 4 on the input side. Using a rack and tie rods, the overall steering angle is transmitted to steered wheels 5, and a wheel steering angle δ_{R} is generated. A control and regulation unit 6 receives steering angle δ_{S} applied by the driver, and instantaneous driving speed vₓ of the vehicle as input variables. A VSR (variable steering ratio) functionality implemented in control and regulation unit 6 uses the input variables to calculate a setpoint for final control element 1.

If a motor vehicle is cornering, a slip angle αᵥ is generated at the wheels—which have been abstracted to one wheel—of the steered front axle, and a corresponding slip angle αₕ is generated at the rear axle.

An understeering behavior during cornering is defined as αᵥ−αₕ>0, an oversteering behavior is defined as αᵥ−αₕ<0. During cornering, a motor vehicle generally tends to exhibit understeering behavior. FIG. 1 shows slip angle α of the front axle in abstracted form at one steered wheel of the axle. Slip angle α is formed between speed vector v of the wheel and wheel steering angle δ_{R} when the vehicle exhibits understeering behavior.

In motor vehicles equipped with a superposed steering system as described, for example, in German Published Patent Application No. 197 51 125, it is possible to implement autonomous dynamic-performance-related steering interventions for the purpose of restoring the vehicle's controllability. In this context, reference is also made to the pertinent publications by Anton van Zanten in connection with a vehicle dynamics control.

According to example embodiments of the present invention, the understeering behavior of a heavily understeering vehicle is reduced with the aid of a superposed steering system.

According to example embodiments of the present invention, in this state, the setpoint for the auxiliary steering angle is modified such that overall steering angle δ_{G} and, correspondingly, wheel steering angle δ_{R} is reduced according to the relation δ_{S}+δ_{Z} and returned to, and kept within, a range of the maximum lateral guidance force F_{y,max} of the wheel.

Thus, with the aid of the superposed steering system, an optimum wheel steering angle δ_{R} at which a maximally achievable lateral force is acting on the wheel is set, so that a maximally possible transverse acceleration of the vehicle is achieved.

It is therefore provided to detect the maximum value of the lateral guide force with the aid of the estimated rack force.

Wheel steering angle δ_{R} is produced by the additive superpositioning of a driver-steering angle δ_{S} applied by the driver, and an auxiliary steering angle δ_{Z} applied by the final control element, which results in an overall steering angle δ_{G} according to the relation δ_{S}+δ_{Z}. Overall steering angle δ_{G} is transmitted to the steered wheels with the aid of the steering gear and the tie rods and thus substantially corresponds to wheel steering angle δ_{R} of the wheels—abstracted to one wheel—of the steered front axle.

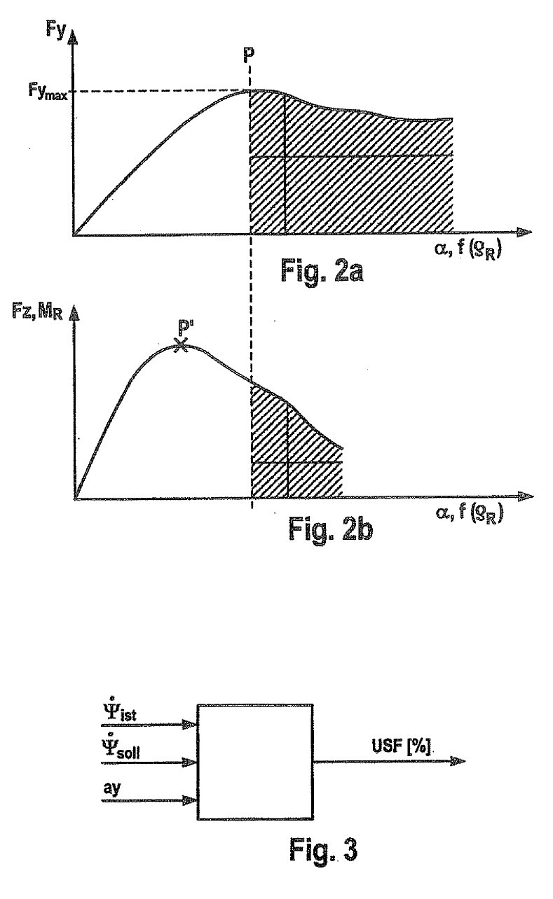

When analyzing the correlation between lateral wheel force F_{y} and wheel steering angle δ_{R} or a slip angle α resulting therefrom, as shown in FIG. 2a, then it becomes clear that, starting at a certain value, it is no longer possible to generate an additional lateral guide force.

As wheel steering angle δ_{R} continues to increase, the lateral guide force decreases.

This transition is denoted by point P in FIG. 2a. To the right of this point, the vehicle is in an understeering state (shaded area). According to example embodiments of the present invention, the state in which a further increase of wheel steering angle δ_{R}, i.e., a further increase in the wheel angle, no longer results in a further increase in the lateral wheel force, is detected.

FIG. 2b illustrates the associated wheel return torque M_{R} of the wheel, or rack force F_{Z} acting on the rack according to the lateral force. With respect to slip angle α, maximum P for rack force F_{Z} or wheel return torque M_{R} manifests itself more clearly and earlier as a result of the wheel properties. Accordingly, point P of maximum lateral guide force F_{y,max} is in a range in which the rack force is decreasing again once the maximum denoted by point P′ has been exceeded. This recognition is quite helpful for the reliable detection of an understeering state.

Since the maximum lateral guide force decreases as the coefficient of friction drops and accordingly, the wheel load differential as well, the tie-rod forces that are obtained are also lower because of the wheel properties. This results in threshold values as a function of the transverse acceleration. The instantaneous tie-rod force may be determined with the aid of an estimating algorithm, as described in German Published Patent Application No. 10 2006 036 751, which is expressly incorporated herein in its entirety by reference thereto.

The understeering state may be identified by evaluating a previously determined understeering factor USF, as shown schematically in FIG. 3.

Setpoint yaw rate Ψₛₒₗₗ, instantaneous yaw rate Ψᵢₛₜ and transverse acceleration a_{y} are forwarded to an arithmetic-logical functional unit 301.

These variables are offset internally and plausibilized with respect to each other, in order to determine a value that specifies the degree of understeering, USF %, therefrom. A subsequent evaluation and decision unit utilizes this as well as additional variables for a binary decision as to whether an understeering state is present.

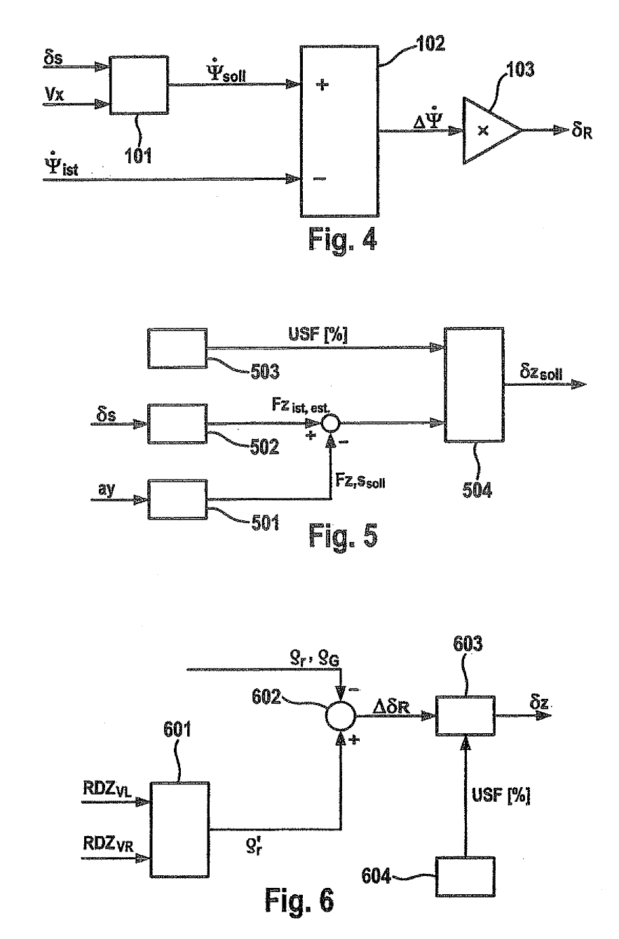

FIG. 4 shows an alternative method as a further exemplary embodiment. Steering angle δ_{S} applied by the driver, and vehicle velocity vₓ are forwarded to a vehicle reference model 101. From these, a setpoint yaw rate Ψₛₒₗₗ is determined and compared to measured instantaneous yaw rate Ψᵢₛₜ.

A differential element 102 arithmetically determines a yaw-rate deviation value ΔΨ, and wheel-steering angle δ_{R} to be adjusted by the appropriate setting of the setpoint for the auxiliary steering angle δ_{Z}, using an amplification element 102, is specified accordingly.

Functional block 301 may be stored as computer-implemented method in control and regulation unit 6.

FIG. 5 shows a further method according to an example embodiment of the present invention. Instantaneous transverse acceleration a_{y} is forwarded to functional block 501, which converts lateral guide force F_{y} into a tie-rod force F_{S} based on vehicle-specific variables such as the center of gravity of the vehicle and the geometric axle and steering conditions.

With the aid of internally known variables of the power steering system, in particular using information related to angle and torque, functional block 502, which includes an estimation algorithm for determining tie-rod force F_{S} or rack force F_{Z}, determines a rack force F_{Z} or tie-rod force F_{S} assumed to be real, which is acting on the rack.

The output variables of both functional blocks 501, 502 are forwarded to a comparison device, the estimated tie-rod force determined with the aid of functional block 502 serving as actual value, and the tie-rod force coming from functional block 501 serving as setpoint.

A subsequent regulation stage 504 determines a setpoint for auxiliary steering angle δ_{Z, soll} to be set, with mandatory consideration of the instantaneous driving state determined in functional block 503, i.e., in the presence of a state evaluated as understeering state. Functional block 503 is used to determine the degree of understeering and operates according to the method described in connection with FIG. 3.

An example embodiment of the present invention is shown in FIG. 6.

The wheel speeds of the steered wheels of the front axle, RDZᵥₗ, RDZᵥᵣ, are detected and transmitted to a functional block 601 for the calculation of a virtual wheel-steering angle δ_{R}′. For one, in wide ranges, virtual wheel-steering angle δ_{R}′ is practically identical to actually applied wheel-steering angle δ_{R}, and for another, it also indicates the qualitative characteristic of transverse acceleration a_{y}.

It also is constant once the maximum transverse acceleration has been reached.

Wheel-steering angle difference Δδ_{R} determined by comparison device 602 is forwarded to a subsequent regulation stage 603, which determines a setpoint for auxiliary steering angle δ_{Z} in order to minimize an existing difference in the wheel-steering angle. Functional unit 604 is used to determine the degree of understeering and operates according to the method described in connection with FIG. 3. Depending on its input of understeering factor USF %, regulation stage 603 is switched into an active or inactive mode. A correction value for the auxiliary steering angle is calculated accordingly and either applied or set to zero. In this case, the information regarding the understeering state USF % need not necessarily be forwarded to regulation stage 603. It is mainly used for a plausibility check.

What is claimed is:

1. A method for controlling a motor vehicle via driving dynamics using an auxiliary steering system, including a power steering assistance unit, a superposed transmission, and a final control device adapted to correct a driver-steering angle by applying an auxiliary steering angle, an overall steering angle being formed to modify a wheel-steering angle of steered wheels with the aid of the superposed transmission, and a control and regulation unit assigned to the final control device adapted to determine a setpoint for the auxiliary steering angle, comprising:
modifying, in response to detecting an understeering state, the setpoint of the auxiliary steering angle such that a lateral wheel force is kept within a range of a maximally achievable maximum value for the lateral wheel force, dependent upon environmental influences, for a duration of the understeering state.

2. The method according to claim 1, further comprising determining the setpoint for the auxiliary steering angle as specified by a differential value, from a value of at least one of (a) a tie-rod force and (b) a rack force determined in accordance with an estimator and a setpoint for at least one of (a) the tie-rod force and (b) the rack force determined from an instantaneous transverse acceleration by a calculation unit.

3. The method according to claim 1, further comprising:
determining a virtual wheel-steering angle from wheel-speed information of steered front wheels of an axle;
continually comparing the virtual wheel-steering angle to a variable that is suitable for describing an instantaneous wheel-steering angle;
determining a setpoint for the auxiliary steering angle in accordance with a deviation between the virtual wheel-steering angle and the variable.

4. The method according to claim 1, further comprising determining the setpoint for the auxiliary steering angle according to a differential value between an actual yaw rate and a setpoint yaw rate determined in accordance with a vehicle reference model, the vehicle reference model receiving at least a linear vehicle velocity and the driver-steering angle as input variables.

5. The method according to claim 1, further comprising detecting the understeering behavior by a driving-state detection unit, the driving-state detection unit receiving, as input variables, an instantaneous yaw rate, a setpoint yaw rate, and a transverse acceleration, the driving-state detection unit determining, from the input variables and in accordance with at least one of (a) stored algebraic algorithms, (b) a state machine, and (c) a fuzzy logic, a variable that is suitable for describing an instantaneous understeering behavior, an understeering state being derived thereby, according to which specification a regulation method for determining the setpoint of the auxiliary steering angle is controlled.

6. A method for controlling a motor vehicle via driving dynamics using an auxiliary steering system including a power steering assistance unit, a superposed transmission, and a final control device, comprising:
applying, by the final control device, an auxiliary steering angle to correct a driver-steering angle;
forming an overall steering angle, by the superposed transmission, to modify a wheel-steering angle of steered wheels;
determining, by a control and regulation unit assigned to the final control device, a setpoint for the auxiliary steering angle; and
modifying, in response to a detection of an understeering state, the setpoint of the auxiliary steering angle to keep a lateral wheel force within a range of a maximally achievable maximum value for the lateral wheel force, dependent upon environmental influences, for a duration of the understeering state.

7. A control device for controlling an auxiliary steering system, including a power-assisted support unit, a superposed transmission, and a final control element adapted to correct a driver-steering angle by application of an auxiliary steering angle, an overall steering angle being formed for modification of a wheel-steering angle of steered wheels by the superposed transmission, and a control and regulation unit assigned to the final control element and adapted to determine a setpoint for the auxiliary steering angle, wherein the control device is adapted to perform a method including modifying, in response to detecting an understeering state, the setpoint of the auxiliary steering angle such that a lateral wheel force is kept within a range of a maximally achievable maximum value for the lateral wheel force, dependent upon environmental influences, for a duration of the understeering state.
